(19) United States
(12) Patent Application Publication
(10) Pub. No.: US 2023/0376598 A1
(43) Pub. Date: Nov. 23, 2023

(54) MALWARE INFECTION MITIGATION OF CRITICAL COMPUTER SYSTEMS

(71) Applicant: BRITISH TELECOMMUNICATIONS PUBLIC LIMITED COMPANY, London (GB)

(72) Inventors: Xiao-Si WANG, London (GB); Conor HOCKING, London (GB)

(21) Appl. No.: 18/247,121

(22) PCT Filed: Sep. 27, 2021
(86) PCT No.: PCT/EP2021/076482

§ 371 Date: Mar. 29, 2023

(30) Foreign Application Priority Data
Sep. 29, 2020 (GB) 2015374.8

(51) Int. Cl. G06F 21/56; G06F 21/55

(52) U.S. Cl. CPC G06F 21/566; G06F 21/552; G06F 2221/034

(57) ABSTRACT

A computer implemented malware protection method to protect a target computer system in a set of computer systems from a malware, the method comprising: accessing a model of the set of computer systems, the model identifying interacting pairs of the computer systems in the set based on interactions corresponding to previous communication occurring between the computer systems in the pairs, and the model identifying the target computer system; simulating, over a plurality of time periods, a propagation of the malware originating from a predetermined source computer system in the model, the simulation being based on a number of interactions per time period between each interacting pair of computer systems in the set, and a rate of transmission of the malware per interaction; evaluating, for each of at least a subset of the time periods, a probability of infection of the target computer system in the time period; responsive to the simulating step, identifying an earliest time period during which the probability of infection of the target computer system meets a predetermined threshold probability; and triggering the deployment of malware protection measures in respect of the target computer system at a time period selected with reference to the identified time period so as to protect the target computer system from the malware.

### PRIORITY CLAIM

The present application is a National Phase entry of PCT Application No. PCT/EP2021/076482, filed Sep. 27, 2021, which claims priority from GB Patent Application No. 2015374.8, filed Sep. 29, 2020, each of which is hereby fully incorporated herein by reference.

### TECHNICAL FIELD

The present disclosure relates to the propagating of malware across a set of computer systems and the automatic mitigation of the malware for critical computer systems.

### BACKGROUND

Conventional malware protection mechanisms are reactive to the detection of malware in a network or the widespread distribution of anti-malware measures. Such approaches are known as “diagnosis and treatment”. Similar techniques are used to combat the spread of biological infections. Mitigation measures such as anti-malware or malware-specific protective measures may not be known for some time after an infection has been studied for its effects. Further, the deployment of mitigation measures to an entire population of susceptible hosts in short order can be impractical and can involve rendering hosts unusable during the critical malware propagation period. In particular, critical computer systems such as computer systems the operation of which is of great importance, are beneficially maintained operational without disconnection or remediation (which can involve interruption) until a replacement, shadow or alternative critical system is available, even during a malware outbreak.

### SUMMARY

Accordingly, it is beneficial to provide improvements to the deployment of protections for malware for critical computer systems.

According to a first aspect of the present disclosure, there is provided a computer implemented malware protection method to protect a target computer system in a set of computer systems from a malware, the method comprising: accessing a model of the set of computer systems, the model identifying interacting pairs of the computer systems in the set based on interactions corresponding to previous communication occurring between the computer systems in the pairs, and the model identifying the target computer system; simulating, over a plurality of time periods, a propagation of the malware originating from a predetermined source computer system in the model, the simulation being based on a number of interactions per time period between each interacting pair of computer systems in the set, and a rate of transmission of the malware per interaction; evaluating, for each of at least a subset of the time periods, a probability of infection of the target computer system in the time period; responsive to the simulating, identifying an earliest time period during which the probability of infection of the target computer system meets a predetermined threshold probability; and triggering the deployment of malware protection measures in respect of the target computer system at a time period selected with reference to the identified time period so as to protect the target computer system from the malware.

In some examples, the simulating, evaluating and responsive to the simulating are repeated a plurality of times to establish the earliest time period during which the probability of infection of the target computer system exceeds the predetermined threshold probability with confidence intervals for selecting an earliest time period having a confidence meeting a threshold degree of confidence.

In some examples, deploying malware protection measures comprises provisioning a replacement computer system for the target computer system as a replica of the target computer system supplemented by the provision of protection measures such that the replacement computer system is protected from the malware, wherein the replacement computer system is provisioned in advance of the selected time period, the method further comprising deploying the replacement computer system as a substitute for the target computer system at the selected time period.

In some examples, malware protection measures include one or more of: an anti-malware facility; a malware filter; a malware detector; a block, preclusion or cessation of interaction; and a reconfiguration of one or more computer systems.

In some examples, the simulating is performed a plurality of times for the source computer system and the responsive to the simulating is responsive to the plurality of simulatings.

In some examples, the simulating is performed a plurality of times for each of multiple different source computer systems, and the responsive to the simulating is responsive to the plurality of simulatings.

In some examples, the number of interactions per time period between an interacting pair of computer systems is determined based on a statistical distribution such as a Poisson or uniform distribution.

In some examples, the number of interactions per time period between an interacting pair of computer systems in the set is defined based on historical records of interactions between the interacting pair of computer systems.

In some examples, the model further identifies a class of interaction between interacting pairs of computer systems, the class of interaction being determined based on historical records of interactions between each computer system in an interacting pair, and wherein the rate of transmission of the malware per interaction is determined for each interacting pair of computer systems based on the class of interaction for the interacting pair.

According to a second aspect of the present disclosure, there is a provided a computer system including a processor and memory storing computer program code for performing the method set out above.

According to a third aspect of the present disclosure, there is a provided a computer system including a processor and memory storing computer program code for performing the method set out above.

### BRIEF DESCRIPTION OF THE DRAWINGS

Embodiments of the present disclosure will now be described, by way of example only, with reference to the accompanying drawings, in which:

FIG. 1 is a block diagram a computer system suitable for the operation of embodiments of the present disclosure.

FIG. 2 is a component diagram of an arrangement for malware protection for at least a subset of a set of computer systems according to an embodiment of the present disclosure.

FIG. 3 is a flowchart of a malware protection method according to an embodiment of the present disclosure.

FIG. 4 is a component diagram of an arrangement for malware protection for at least a subset of a set of computer systems according to an embodiment of the present disclosure.

FIG. 5 is a flowchart of a malware protection method according to an embodiment of the present disclosure.

### DETAILED DESCRIPTION

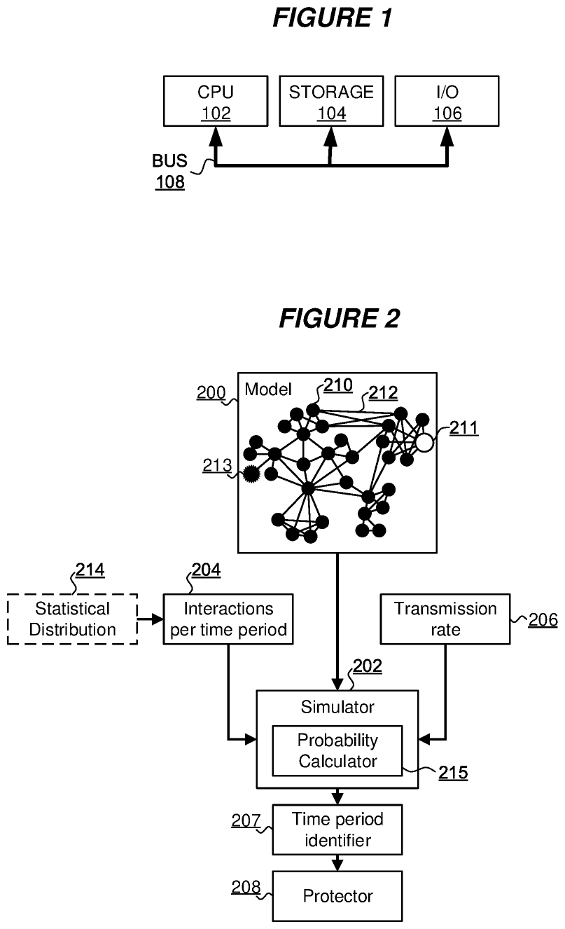

FIG. 1 is a block diagram of a computer system suitable for the operation of embodiments of the present disclosure. A central processor unit (CPU) 102 is communicatively connected to a storage 104 and an input/output (I/O) interface 106 via a data bus 108. The storage 104 can be any read/write storage device such as a random-access memory (RAM) or a non-volatile storage device. An example of a non-volatile storage device includes a disk or tape storage device. The I/O interface 106 is an interface to devices for the input or output of data, or for both input and output of data. Examples of I/O devices connectable to I/O interface 106 include a keyboard, a mouse, a display (such as a monitor) and a network connection.

Malicious software, also known as computer contaminants or malware, is software that is intended to do direct or indirect harm in relation to one or more computer systems. Such harm can manifest as the disruption or prevention of the operation of all or part of a computer system, accessing private, sensitive, secure and/or secret data, software and/or resources of computing facilities, or the performance of illicit, illegal or fraudulent acts. Malware includes, inter alia, computer viruses, worms, botnets, trojans, spyware, adware, rootkits, keyloggers, dialers, malicious browser extensions or plugins and rogue security software.

Malware proliferation can occur in a number of ways. Malware can be communicated as part of an email such as an attachment or embedding. Alternatively, malware can be disguised as, or embedded, appended or otherwise communicated with or within, genuine software. Some malware is able to propagate via storage devices such as removable, mobile or portable storage including memory cards, disk drives, memory sticks and the like, or via shared or network attached storage. Malware can also be communicated over computer network connections such as the internet via websites or other network facilities or resources. Malware can propagate by exploiting vulnerabilities in computer systems such as vulnerabilities in software or hardware components including software applications, browsers, operating systems, device drivers or networking, interface or storage hardware.

A vulnerability is a weakness in a computer system, such as a computer, operating system, network of connected computers or one or more software components such as applications. Such weaknesses can manifest as defects, errors or bugs in software code that present an exploitable security weakness. An example of such a weakness is a buffer-overrun vulnerability, in which, in one form, an interface designed to store data in an area of memory allows a caller to supply more data than will fit in the area of memory. The extra data can overwrite executable code stored in the memory and thus such a weakness can permit the storage of malicious executable code within an executable area of memory. An example of such malicious executable code is known as ‘shellcode’ which can be used to exploit a vulnerability by, for example, the execution, installation and/or reconfiguration of resources in a computer system. Such weaknesses, once exploited, can bootstrap a process of greater exploitation of a target system, and propagation of the malware to other computer systems.

The effects of malware on the operation and/or security of a computer system lead to a need to identify malware in a computer system in order to implement protective and/or remedial measures. While malware detection is often directed to computer systems themselves or the networks over which they communicate, embodiments of the present disclosure recognize that interactions between computer systems transcend the physical interconnections therebetween. In particular, embodiments of the present disclosure are directed to addressing interactions between computer systems that arise from communication between pairs of computer systems. Such interactions can include, for example, interactions between users of each of a pair of computer systems using, inter alia, social media, messaging, electronic mail or file sharing facilities. Thus, embodiments of the present disclosure employ a model of a set of computer systems in which interacting pairs of computer systems are identified, such interactions being based on previous communication occurring between the computer systems in the pair. Notably, such a model disregards intermediates in an interaction—such as physical resources or other computer systems involved in a communication. For example, an interaction arising from a social media communication between two users using each of a pair of computer systems will involve potentially multiple physical or logical networks, intermediate servers, service provider hosts, intermediate communication appliances and the like. Thus, a model of the physical communication becomes burdened by the intermediate features of a typical inter-computer communication. In contrast, embodiments of the present invention address the endpoints of an interaction such as the computer systems through which users communicate. A similar analysis can be conducted for interactions involving email, electronic messaging, file sharing and the like.

Embodiments of the present disclosure are directed to the deployment of malware protection measures for a specific target computer system. Such target computer system can be, for example, inter alia, a critical computer system the operation of which is critical, a computer system storing sensitive data, a computer system the continuing availability of which is essential for operational or performance reasons, or the like. The deployment of malware protection measures to the target computer system is therefore sensitive to any non-availability of the target system that may arise due to the deployment or protection of the target system. For example, installation of malware protection measures can involve the temporary disconnection or cessation of network communications for the target system, a temporary cessation of operation of the target system, a reboot, restart or reconfiguration of the target system or the like, any or all of which may result in a period of non-availability of the target system. Embodiments of the present disclosure identify a time period during which the target system is at risk of impact by the malware with a probability exceeding a threshold degree of probability such that protective measures can be deployed with reference to the identified time period such as immediately before, or some time before, the time period so providing a continuation of the target system preceding such deployment. In one embodiment, during the continuation of the target system preceding such deployment, a replacement computer system is provisioned to replace the target computer system. Such replacement system can be a replica of the target computer system supplemented by the provision of protection measures such that the replacement computer system is protected from the malware. The replacement computer system can be provisioned in advance of the identified time period and deployed as a substitute for the target computer system at the selected time period. Accordingly, the targeted computer system can be permitted to continue its operation until the identified time period before being de-provisioned (e.g. deleted, switched off, disconnected or the like) and substituted by the replacement computer system. In this way, continuity of provision of any services, facilities and/or functions of the target computer system can be provided in spite of an active threat posed by a malware infection.

Embodiments of the present disclosure are based on a simulation of a propagation of malware through a model of a set of computer systems. Such simulation employs simulation parameters including: a rate of interaction between each interacting pair of computer systems (i.e. a number of interactions per time period); and a rate of transmission of the malware between interacting computer per interaction. In some embodiments, some or all of these parameters are derived statistically according to a statistical distribution. In some embodiments, some or all of these parameters are determined based on historical interaction information over a historical time period. In some embodiments, some or all of these parameters are determined based on one or more machine learning processes based on historical interaction information.

FIG. 2 is a component diagram of an arrangement for malware protection for at least a subset of a set of computer systems according to an embodiment of the present disclosure. A model 200 is provided as one or more data structures representing a set of computer systems and interactions therebetween. In some examples, the model is provided as a graph or similar data structure including nodes or vertices 210, each corresponding to a computer system, and edges 212 each connecting a pair of nodes 210 and representing interaction between computer systems corresponding to each node in the pair. Thus, an edge 212 represents interaction between a pair of computer systems. Each node 210 can have associated information for a corresponding computer system including, for example, inter alia: an identifier of the computer system; an identification of an organizational affiliation of the computer system; an identifier of a subnet to which the computer system is connected; and other information as will be apparent to those skilled in the art. A target computer system 211 is indicated in the model 200. Further, one or more computer systems 213 as origins on a malware infection are similarly indicated.

In some examples, an edge 212 constitutes an indication that at least one interaction has taken place over at least a predetermined historic time period between computer systems in a pair. In some examples, the existence of an edge 212 is not determinative, indicative or reflective of a degree, frequency or propensity of interaction between computer systems in a pair—rather, the edge 212 identifies that interaction has taken place. In some embodiments, edges 212 can have associated, for example, inter alia: an edge identifier; an identification of a pair of nodes (and/or the corresponding computer systems) that the edge interconnects; and/or interaction frequency information between a pair of computer systems. It will be appreciated by those skilled in the art that, while the model 200 is illustrated as a literal graph in the arrangement of FIG. 2, alternative data structures and logical representations of vertices and edges can be used, such as representations employing, for example, inter alia, vectors, arrays of vectors, matrices, compressed data structures and the like.

The arrangement of FIG. 2 includes a simulator 202 as a hardware, software, firmware or combination component arranged to perform a simulation of a propagation of a malware in the set of computer systems represented by the model 200. The simulator 202 is operable on the basis of simulation parameters including: an interaction rate 204 as a number of interactions between pairs of interacting computer systems in a time period; and a transmission rate 206 as a rate of transmission of a malware between computer systems in a pair of systems per interaction. In some examples, the transmission rate 206 is a probability of transmission of a malware from one node to another node during an interaction between the nodes. In some examples, the transmission rate 206 incorporates aspects of a malware infection process. For example, in the case of malware transmitted as a web-link between two computer systems by email, the transmission rate can reflect all of: a probability that an email is communicated between the two computer systems; a probability that the email includes the malicious web-link; and a probability that a recipient accesses the malicious web-link resulting in malware infection.

In one embodiment, the interactions rate 204 is sampled from one or more statistical distributions 214 to model different types of interaction. For example, a Poisson or uniform distribution can be used to model a number of interactions between a pair of computer systems over a time period, such as a number of emails communicated over the time period. In one embodiment, the transmission rate 206 is initialized in advance, such as by a predetermined value. For example, a transmission rate 206 having a value of 0.0001 is indicative of a probability that a first computer system in an interacting pair of computer systems transmits a malware to a second computer system in the pair within a single predetermined time period is 0.0001. In one embodiment, the interaction rate 204 between each of an interacting pair of computer systems in the set of computer systems is defined based on historical records of interactions between the computer systems.

In one embodiment, the model 200 further identifies a class of interaction between interacting pairs of systems based on historical records of interactions between each system in an interacting pair. In such embodiments, a rate of transmission of the malware per interaction is determined for each interacting pair of computer systems based on the class of interaction for the interacting pair.

The simulator 202 can operate on the basis of configurable characteristics such as simulation assumptions. For example, the simulator 202 may operate on the basis that any computer system as represented by a node in the model 200 can only transmit the malware to first-degree neighbors according to the model 200. Further, the simulator 202 can operate on the basis that each computer system has a state of infection at a point in time. States of infection at a point in time can include, for example: a state of susceptibility in which a computer system is susceptible to infection, such as a computer system that is not and has not been so far infected and is not specifically protected from infection by a particular malware; a state of infected in which a computer system is subject to infection by the malware at the point in time; and a state of removed or remediated in which a computer system is remediated of a past infection or protected from prospective infection by the malware. It will be appreciated by those skilled in the art that sub-states of these states can also be employed, such as, inter alia: an infected state that is not infectious (i.e. transmission of malware cannot be effected by a computer system in such a state); an infected state that is infectious; an infected state that is detected; and an infected state that is not detected (such as might be determined by the simulator 202).

Thus, in use, the simulator 202 is operable for a time period to model the propagation of a malware infection. In one embodiment, one or more predetermined source computer systems 213 represented in the model 200 are selected as originating computer systems for the malware infection such that propagation is simulated from such originating computer systems. The simulator 202 is executed for each of a plurality of time periods so as to model the propagation of the malware in the set of computer systems over time. Additionally or alternatively, the simulator 202 can be performed a plurality of times for each of a plurality of predetermined source computer systems selected as originating computer systems 213 for the malware infection.

According to one embodiment, where the transmission rate 206 is denoted as p, and the interaction rate 204 is denoted as c, the simulator 202 can model propagation of a malware by formulating an infection probability of a susceptible computer system indicated as node i by its infected neighbors:
Considering nodeᵢ where i∈{1, . . . , n} where n =number of nodes in the model,
nodeᵢ's infectious neighbours Nhb_{i,j}={nhb_{i,1}, . . . , nhb_{i,m}_{⁽ⁱ⁾}} where j∈{1, . . . , m⁽ⁱ⁾} and mⁱ
   ∈ [symbol] is the number of neighbours of nodeᵢ
The corresponding set of interactions are Inter_{i,j}={c_{i,1}, . . . c_{i,m}_{⁽ⁱ⁾}}.

$$P ( N h {b}_{i} infects {node}_{i} ) = P ( nh {b}_{i , 1} infects {node}_{i} during any of their {c}_{i , 1} interactions = 1 - {\prod }_{i} {P ( n h {b}_{i , j} does not infect {node}_{i} during an interaction )}^{{c}_{i , j}} = 1 - {\prod }_{j} {( 1 - p )}^{{c}_{i , j}} = 1 - {( 1 - p )}^{{\sum }_{j = 1}^{{m}^{( i )}} {c}_{i , j}}$$

Thus, an exemplary model for the simulator 202 to model transitions of nodes 210 from a state of susceptible to infected and from infected to removed (i.e. remediated) can be:

| | |
|---|---|
| Probability of a node transitioning from a susceptible state to an infected state | $1 - {( 1 - p )}^{{\sum }_{j = 1}^{{m}^{( i )}} {c}_{i , j}}$ |
| Probability of a node in a susceptible state remaining in the susceptible state | ${( 1 - p )}^{{\sum }_{j = 1}^{{m}^{( i )}} {c}_{i , j}}$ |
| Probability of a node transitioning from an | θᵣ |
| infected state to a removed state | |
| Probability of a node in an infected state | 1 − θᵣ |
| remaining in the infected state | |
| Probability of a node in the removed state | 1 |
| remaining in the removed state | |

where θ is a rate of removal/remediation.

The simulator 202 includes a probability calculator component 251 operable to evaluate a probability of infection of the target computer system 211 in each time period of the simulation. The probability calculator 215 can be operable across or on the basis of multiple executions of the simulator 202 to arrive at probabilities, for each time period, of infection of the target system 211. A time period identifier 207 component is a hardware, software, firmware or combination component operable to identify an earliest time period of the simulation during which a probability of infection of the target system 211 meets or exceeds a predetermined threshold. Such predetermined threshold is determined to be a probability at or above which the risk of infection of the target system 211 is considered too great to permit the continued operation of the target system 211 without protective measures. Thus, during time periods where the probability does not meet the threshold, operation of the target system 211 continues.

Responsive to the simulation by the simulator 202 and the identified earliest time period, a protector component 208 is operable to deploy malware protection measures intended to inhibit a propagation of the malware to the target system 211. The protector component 208 is a hardware, software, firmware or combination component arranged to access output from the time period identifier 207 to trigger the deployment of protective measures in respect of the target system 211 at a selected time period. The protector 208 selects the selected time period with reference the earliest time period identified by the time period identifier 207 such that the selected time period for deployment of protective measures occurs before the earliest time period so as to protect the target system 211 from the malware. Protections deployed with respect of the target system 211 can include protections deployed in or at the target system and protections deployed in other systems such as adjacent, connected or communicating systems or a replacement system as previously described. Protections can include, for example, inter alia: an anti-malware facility; a malware filter; a malware detector; a block, preclusion or cessation of interaction; and a reconfiguration of one or more computer systems.

In some embodiments the simulation, probability calculation and time period identification are performed repeatedly to establish a range of earliest time periods during which a probability of infection of the target system 211 meets the threshold probability so that a set of earliest time periods can be identified each associated with a confidence interval based on the multiple simulations. In such embodiments, the identified time period can be determined based on a threshold confidence, for example.

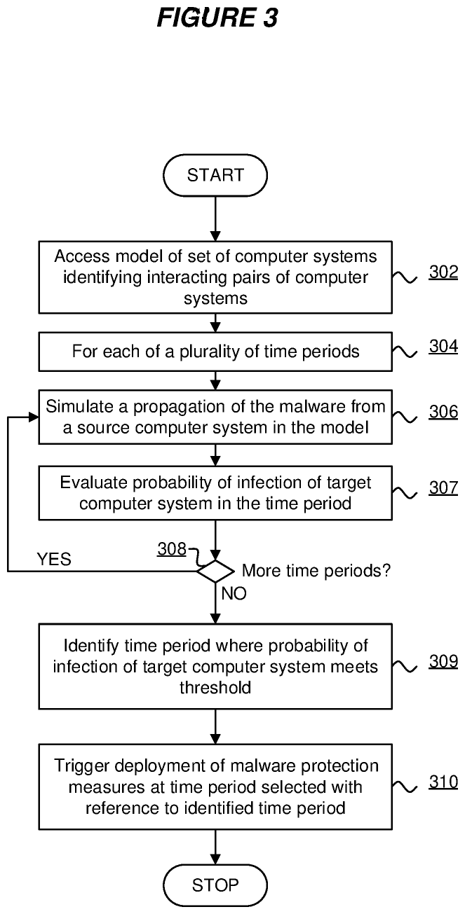

FIG. 3 is a flowchart of a malware protection method according to an embodiment of the present disclosure. Initially, at 302, the method accesses a model of a set of computer systems identifying interacting pairs of the computer systems based on interactions corresponding to previous communication occurring between the computer systems in the pair. At 304 the method commences an iteration between each of a plurality of time periods for simulation. At 306, for each simulated time period, the method simulates a propagation of a malware originating from a predetermined source computer system 213 in the model. The simulation is based on a number of interactions per time period 204 between each interacting pair of computer systems in the set, and a rate of transmission 206 of the malware per interaction. At 307 the method evaluates a probability of infection of the target system 211 in the current time period. The method loops at 308 through the time periods. Subsequently, at 309, the method identifies a time period where the probability of infection of the target system 211 meets the threshold probability. At 310 the method triggers deployment of malware protection measures for the target system 211 at a time period selected with reference to the identified time period.

Insofar as embodiments of the disclosure described are implementable, at least in part, using a software-controlled programmable processing device, such as a microprocessor, digital signal processor or other processing device, data processing apparatus or system, it will be appreciated that a computer program for configuring a programmable device, apparatus or system to implement the foregoing described methods is envisaged as an aspect of the present disclosure. The computer program may be embodied as source code or undergo compilation for implementation on a processing device, apparatus or system or may be embodied as object code, for example.

Suitably, the computer program is stored on a carrier medium in machine or device readable form, for example in solid-state memory, magnetic memory such as disk or tape, optically or magneto-optically readable memory such as compact disk or digital versatile disk etc., and the processing device utilizes the program or a part thereof to configure it for operation. The computer program may be supplied from a remote source embodied in a communications medium such as an electronic signal, radio frequency carrier wave or optical carrier wave. Such carrier media are also envisaged as aspects of the present disclosure.

It will be understood by those skilled in the art that, although the present disclosure has been described in relation to the above described example embodiments, the disclosure is not limited thereto and that there are many possible variations and modifications which fall within the scope of the disclosure.

The scope of the present disclosure includes any novel features or combination of features disclosed herein. The applicant hereby gives notice that new claims may be formulated to such features or combination of features during prosecution of this application or of any such further applications derived therefrom. In particular, with reference to the appended claims, features from dependent claims may be combined with those of the independent claims and features from respective independent claims may be combined in any appropriate manner and not merely in the specific combinations enumerated in the claims.

1. A computer implemented malware protection method to protect a target computer system in a set of computer systems from a malware, the method comprising:
accessing a model of the set of computer systems, the model identifying interacting pairs of the computer systems in the set based on interactions corresponding to previous communication occurring between the computer systems in the pairs, and the model identifying the target computer system;
simulating, over a plurality of time periods, a propagation of the malware originating from a predetermined source computer system in the model, the simulation being based on a number of interactions per time period between each interacting pair of computer systems in the set, and a rate of transmission of the malware per interaction;
evaluating, for each of at least a subset of the time periods, a probability of infection of the target computer system in the time period;
responsive to the simulating, identifying an earliest time period during which the probability of infection of the target computer system meets a predetermined threshold probability; and
triggering deployment of malware protection measures in respect of the target computer system at a time period selected with reference to the identified time period so as to protect the target computer system from the malware.

2. The method of claim 1, wherein the simulating, the evaluating, and the responsive to the simulating are repeated a plurality of times to establish the earliest time period during which the probability of infection of the target computer system exceeds the predetermined threshold probability with confidence intervals for selecting an earliest time period having a confidence meeting a threshold degree of confidence.

3. The method of claim 1, wherein deploying malware protection measures comprises provisioning a replacement computer system for the target computer system as a replica of the target computer system supplemented by the provision of protection measures such that the replacement computer system is protected from the malware, wherein the replacement computer system is provisioned in advance of the selected time period, the method further comprising deploying the replacement computer system as a substitute for the target computer system at the selected time period.

4. The method of claim 1, wherein the malware protection measures include one or more of: an anti-malware facility; a malware filter; a malware detector; a block, preclusion or cessation of interaction; or a reconfiguration of one or more computer systems.

5. The method of claim 1, wherein the simulating is performed a plurality of times for the source computer system and the responsive to the simulating is responsive to the plurality of simulatings.

6. The method of claim 1, wherein the simulating is performed a plurality of times for each of multiple different source computer systems, and the responsive to the simulating is responsive to the plurality of simulatings.

7. The method of claim 1, wherein the number of interactions per time period between an interacting pair of computer systems is determined based on a statistical distribution.

8. The method of claim 1, wherein the number of interactions per time period between an interacting pair of computer systems in the set is defined based on historical records of interactions between the interacting pair of computer systems.

9. The method of claim 1, wherein the model further identifies a class of interaction between interacting pairs of computer systems, the class of interaction being determined based on historical records of interactions between each computer system in an interacting pair, and wherein the rate of transmission of the malware per interaction is determined for each interacting pair of computer systems based on the class of interaction for the interacting pair.

10. A computer system comprising:
a processor and memory storing computer program code for implementing malware protection to protect a target computer system in a set of computer systems from a malware by:
accessing a model of the set of computer systems, the model identifying interacting pairs of the computer systems in the set based on interactions corresponding to previous communication occurring between the computer systems in the pairs, and the model identifying the target computer system;
simulating, over a plurality of time periods, a propagation of the malware originating from a predetermined source computer system in the model, the simulation being based on a number of interactions per time period between each interacting pair of computer systems in the set, and a rate of transmission of the malware per interaction;
evaluating, for each of at least a subset of the time periods, a probability of infection of the target computer system in the time period;
responsive to the simulating, identifying an earliest time period during which the probability of infection of the target computer system meets a predetermined threshold probability; and
triggering deployment of malware protection measures in respect of the target computer system at a time period selected with reference to the identified time period so as to protect the target computer system from the malware.

11. A non-transitory computer-readable storage medium storing a computer program element comprising computer program code to, when loaded into a computer system and executed thereon, cause the computer system to implement malware protection to protect a target computer system in a set of computer systems from a malware by:
accessing a model of the set of computer systems, the model identifying interacting pairs of the computer systems in the set based on interactions corresponding to previous communication occurring between the computer systems in the pairs, and the model identifying the target computer system;
simulating, over a plurality of time periods, a propagation of the malware originating from a predetermined source computer system in the model, the simulation being based on a number of interactions per time period between each interacting pair of computer systems in the set, and a rate of transmission of the malware per interaction;
evaluating, for each of at least a subset of the time periods, a probability of infection of the target computer system in the time period;
responsive to the simulating, identifying an earliest time period during which the probability of infection of the target computer system meets a predetermined threshold probability; and
triggering deployment of malware protection measures in respect of the target computer system at a time period selected with reference to the identified time period so as to protect the target computer system from the malware.

12. The method of claim 7, wherein the statistical distribution is as a Poisson distribution or a uniform distribution.
